(19) United States
(12) Patent Application Publication
(10) Pub. No.: US 2020/0316421 A1
(43) Pub. Date: Oct. 8, 2020

(54) PREVENTIVE PROTECTION AGAINST FIRE, IN PARTICULAR FOREST FIRE, INCLUDING A FLAME-RETARDANT SUBSTANCE, FLAME-RETARDANT FABRIC AND FIRE PROTECTION DEVICE COMPRISING THE SAME

(71) Applicant: Thorsten PATZELT, Geretsried (DE)

(72) Inventor: Thorsten PATZELT, Geretsried (DE)

(21) Appl. No.: 16/304,226

(22) PCT Filed: May 24, 2017
(86) PCT No.: PCT/EP2017/062667

§ 371 Date: Nov. 23, 2018

(30) Foreign Application Priority Data
May 25, 2016 (DE) 10 2016 209 165.4
Nov. 24, 2016 (DE) 10 2016 014 083.8

(51) Int. Cl. A62D 1/06; A62C 3/02

(52) U.S. Cl. CPC A62D 1/06; A62C 3/0214

(57) ABSTRACT

Exemplary embodiments of the present disclosure relate to preventive protection against fire, including forest fires. The embodiments include one or any combination of a flame-retardant substance, a flame-retardant composition, a flame-retardant fabric and a fire protection device comprising the same, to obtain different levels of protection. An exemplary flame-retardant substance can be configured for application to objects to be protected, and is obtained by a chemical reaction according to the formula [1]: M₂(CO₃)ₓ+n SiO₂→M₂Oₓ.n SiO₂+x CO₂⬆, wherein x=1, 2 and/or 3 and n is an integer between 1 and 10. The flame-retardant composition can include an exemplary flame-retardant substance in combination with a clay. An exemplary flame-retardant fabric can be configured for covering objects to be protected against fire and includes at least one woven layer containing silica glass. The flame-retardant substance may be applied to the flame-retardant fabric.

The present invention relates to preventive protection against fire, in particular forest fire, including a flame-retardant substance, a flame-retardant fabric and a fire protection device comprising the same.

Forest fires regularly devastate entire landscapes, tree populations and residential areas, causing tremendous damage to public and private property.

While human casualties can be generally avoided by timely evacuation of the areas exposed to the danger of forest fire, immovable properties regularly fall victim to the flames.

Depending on environmental conditions such as wind gusts and the like, the flame front of a forest fire may move with speeds of up to 100 meters per minute in unexpected directions, causing considerable difficulties for firefighters to control forest fire.

Hitherto, there is no satisfying preventive protection against forest fire available.

This creates a strong need for providing preventive protection of objects and the like against fire, in particular forest fire.

In order to address this need, the present invention provides various measures for preventive protection of objects and the like against fire, in particular forest fire, which may be used separately or in combination in order to obtain different levels of protection.

A first embodiment (first aspect) of the present invention relates to a flame-retardant substance for application to objects to be protected against fire, in particular forest fire, wherein the flame-retardant substance is water glass or liquid glass or a substance obtained by a chemical reaction according to the formula [1]:

M₂(CO₃)ₓ+n SiO₂→M₂Oₓ.n SiO₂+x CO₂⬆ [1]

In this formula, M is a monovalent metal (then x=1 in the above formula [1]), a divalent metal (then x=2 in the above formula [1]) and/or trivalent metal (then x=3 in the above formula [1]) and n is an integer between 1 and 10, preferably 1 and 5, more preferably 3-4. More preferably, the retardant substance is waterglass or liquid glass; most preferably the retardant substance is sodium silicate.

Formula [1] may be drafted as formula [1a], [1b], and/or [1c].

M₂CO₃+n SiO₂→M₂O.n SiO₂+CO₂⬆ [1a]

In the embodiment of formula [1a], M is a monovalent metal, preferably sodium or potassium.

In some embodiments, divalent metals are used. In these embodiments MCO₃ instead of or together with M₂CO₃ is used. MCO₃ is employed as follows:

MCO₃+n′ SiO₂→MO.n′ SiO₂+CO₂⬆ [1b]

This formula is equivalent to

M₂(CO₃)₂+n SiO₂→M₂O₂.n SiO₂+2 CO₂⬆ [1b′]

Preferred divalent metals are nickel, calcium or magnesium. Also trivalent metals such as aluminum may be used alone or together with mono and/or divalent metals. In these embodiments the stoichiometric equation is

M₂(CO₃)₃+n SiO₂→M₂O₃.n SiO₂+3 CO₂⬆ [1c]

The flame-retardant substance may be formed under pressure and/or heat, preferably in an aqueous solution. The flame-retardant substance may form a sol or a gel. Upon contact with fire or heat the flame-retardant substance may lose water and may harden to a fire resistant solid.

The object to be protected against fire may be any object, including movable and immovable objects, such as vehicles, buildings, plants of any kind, such as bushes, trees, hedges and the like, as well as preliminary or permanent constructions and the like. The object to be protected against fire may be made from any material or material compound, including metal, plastic, wood, ceramic and the like.

According to a second embodiment of the present invention, the flame-retardant substance of the first embodiment is liquid and/or thinned with a thinning agent, preferably water, more preferably up to a thinning ratio of not more than 1 to 10 by volume or weight. A liquid flame-retardant substance is fairly easy to apply to objects to be protected against forest fire. The preferred way of application of the flame-retardant substance to the object to be protected is surface treatment, e.g. by spraying, sprinkling, glazing, and coating. In a drawn-in state, the flame-retardant substance may have a crystalline structure, which can be easily washed out, e.g. with water, without residues remaining on the treated object.

A third embodiment (second aspect) the present invention relates to a flame-retardant composition. The flame-retardant composition is a mixture of the flame-retardant substance of the first or second embodiment together with a clay mineral. Preferably, the flame-retardant substance of the first or second embodiment is mixed with porcelain clay, kaolinite or kaolin. More preferably the flame-retardant substance of the first or second embodiment is mixed with Kaolinum ponderosum or Bolus alba. Kaolinum ponderosum or Bolus alba are commercially available as industrially or pharmaceutically useful powders. These may be used in the third embodiment of the invention.

More preferably, the mixture of the third embodiment contains the flame-retardant substance of the first or second embodiment and clay mineral in a ratio (w/w) of between 100:1 and 5:1, preferably between 50:1 and 10:1, more preferably 20:1 and 12:1. Preferably, the ratio is the ratio of the dry components flame-retardant substance to clay mineral. In one embodiment, water glass is admixed with kaolin (preferably Kaolinum ponderosum or Bolus alba) in a ratio (w/w) of between 50:1 and 10:1, more preferably 20:1 and 12:1. In another embodiment, sodium silicate is admixed with kaolin (preferably Kaolinum ponderosum or Bolus alba) in a ratio of between 50:1 and 10:1, more preferably 20:1 and 12:1. Water or an aqueous solution may be added to the compositions of the third embodiment of the invention.

Optionally, the third embodiment of the invention may include a filler, such as potash alum or soda alum; and/or a surfactant.

A fourth embodiment (third aspect) the present invention relates to a flame-retardant fabric for covering objects to be protected against fire, in particular forest fire, comprising at least one woven layer containing silica glass, preferably (fibers of) pure silica glass in compound with aramide and/or aluminum silicate, wherein the flame-retardant fabric is more preferably composed of two, three or more identical or different layers. Such flame-retardant fabric is fire-proof and provides a strong physical barrier against flying sparks or the flame front of a forest fire. Preferably, the flame-retardant fabric covers the object to be protected whilst avoiding a direct contact, e.g. by leaving a gap between the fabric and the object, so as to create an additional air buffer. Such a gap can be created by means of spacers, which may form part of the fabric or may be attached to the fabric.

According to the fifth embodiment of the present invention, which may be combined with the forth embodiment, at least one section of the flame-retardant fabric, a plurality of discrete sections of the flame-retardant fabric, or the entire flame-retardant fabric contain(s) the flame-retardant substance according to one of the first and second embodiments, preferably by being dotted or immersed or filled with the flame-retardant substance, wherein more preferably one square meter of the flame-retardant fabric contains between 50 and 150 milliliters, preferably between 80 and 120 milliliters, even more preferably between 95 and 105 milliliters, most preferably 100 milliliters of the flame-retardant substance. The flame-retardant fabric and/or an underlay to be used in combination with the flame-retardant fabric may contain at least one cavity filled or fillable with the retardant substance.

According to the sixth embodiment of the present invention, which may be combined with the fourth or fifth embodiment, the flame-retardant fabric is configured to be coupled and/or comprises coupling means for coupling with at least another flame-retardant fabric, preferably of the same type, for providing a continuous physical barrier against flying sparks and/or a flame front, preferably in an abutting and/or overlapping state. The flame-retardant fabric(s) may have a soft or rigid structure and can be embodied as a shutter, jalousie, curtain, sheet, mat, tissue and the like. The preferred shape of the flame-retardant fabric(s) is rectangular, even though any other shape can be used. In case the flame retardant fabric has a polygonal shape, adjacent flame-retardant fabrics of the same type can be arranged in an abutting fashion so that at least one edge of a first flame-retardant fabric abuts at least one edge of a second flame-retardant fabric, preferably along a straight, edged and/or continuous line. In such way, a continuous flame-resistant barrier against flying sparks or a flame front can be composed of a plurality of flame-retardant fabrics. Preferably, the flame-retardant fabrics can be coupled with each other in an abutting and/or overlapping state with hook-and-eye systems or other coupling technologies. The coupling means may form an integral part of the fabric. One example of the invention relates to a set of flame-retardant fabrics which are embodied as mats having the same predetermined size and shape, so that they can be stacked up for easy transportation. The flame-retardant fabrics can be coupled with each other and/or with a target object e.g. by means of retaining straps and carabiners, preferably in an overlapping state.

A seventh embodiment (fourth aspect) of the present invention relates to a forest fire protection device, preferably comprising at least one flame-retardant fabric according to the third or fourth embodiment, wherein the flame-retardant fabric is transferable from a retracted configuration to a deployed configuration for protecting objects against fire, in particular forest fire, while providing a physical barrier against flying sparks and/or a flame front, wherein the flame-retardant fabric is preferably also transferable from the deployed configuration to the retracted configuration. The device may comprise a sensor and a drive, so that the flame-retardant fabric is automatically deployed by actuation of the drive upon receipt of a respective signal from the sensor. Preferably the flame-retardant fabric is storable in a case, wherein the case is installable at a site exposed to the danger of fire. The case and/or the sensor are preferably heat-resistant and fire-proof. Preferably, the flame-retardant fabric is stored in the case in the retracted configuration and extends outside the case in the deployed configuration.

According to the eighth embodiment of the present invention, which may be combined with the seventh embodiment, the forest fire protection device comprises at least one guide for guiding flame-retardant fabric between the retracted configuration and at least one deployed configuration, wherein preferably two guides are provided for guiding opposite edges of the flame-retardant fabric. The guide is preferably heat-resistant and fire-proof. The guide secures a smooth transfer of the flame-retardant fabric from the retracted configuration to the deployed configuration and keeps the flame-retardant fabric in position in case of exposure to the flame front or strong wind gusts, so that the protective effect of the forest fire protection device is maintained at any required time.

According to the ninth embodiment of the present invention, which may be combined with the seventh or eighth embodiment, the forest fire protection device comprises at least one latching device for latching the flame-retardant fabric in at least one deployed configuration. The latching device keeps the flame-retardant fabric in position relative to the object to be protected in case of exposure to the flame front or strong wind gusts, so that the protective effect of the forest fire protection device can be maintained at any required time. Preferably, the latching device comprises hook-and-eye systems or other coupling technologies.

According to the tenth embodiment of the present invention, which may be combined with one of the sixth to eighth embodiments, the forest fire protection device comprises at least one coupling device for coupling two flame-retardant fabrics in an abutting and/or overlapping state. The coupling device keeps the flame-retardant fabrics in position relative to each other in case of exposure to the flame front or strong wind gusts, so that the protective effect of the forest fire protection device can be maintained at any required time.

An eleventh embodiment (fifth aspect) of the present invention relates to an object treated with the flame-retardant substance according to one of the first and second embodiments, wherein the flame-retardant substance is preferably applied to the object in a liquid state, more preferably by spraying, sprinkling, glazing, dotting, immersing and/or filling.

A twelfth embodiment (sixth aspect) of the present invention relates to the use of the flame-retardant substance according to the first or second embodiment or the flame-retardant fabric according to one of the third to fifth embodiments of the forest-fire protection device according to one of the sixth to ninth embodiments for protecting a flammable object against fire.

A thirteenth embodiment relates to the use according to the eleventh embodiment, wherein the flammable object is part of a house or garden.

Other preferred embodiments of the invention will be obtained by combining the above embodiments with the features disclosed herein in the description, drawings and claims of the present application.

### BRIEF DESCRIPTION OF THE DRAWINGS

FIG. 1 is a schematic front view of a building furnished with a fire protection device according to the invention.

FIG. 2 is a schematic top view of a set of coupleable flame-retardant fabrics coupled with each other by coupling means in an abutting configuration.

FIG. 3 is a schematic sectional view of a flame-retardant fabric containing cavities filled with flame-retardant substance, wherein the flame-retardant fabric is provided with a gap in front of an object to be protected against fire and exposed to the flame front.

### DETAILED DESCRIPTION OF THE PREFERRED EMBODIMENTS

### Flame-Retardant Substance

The flame-retardant substance according to the present invention is obtained by a chemical reaction in accordance with the following formula [1a] below.

M₂CO₃+n SiO₂→M₂O.n SiO₂+CO₂⬆ [1a]

In this formula [1a], M is a monovalent metal, preferably sodium or potassium, n is an integer between 1 and 10 as defined above.

In some embodiments, divalent metals are used. In these embodiments MCO₃ instead of or together with M₂CO₃ is used. MCO₃ is employed as follows:

MCO₃+n SiO₂→MO.n SiO₂+CO₂⬆ [1b]

Preferred divalent metals are nickel, calcium or magnesium. Also trivalent metals such as aluminum may be used alone or together with mono and/or divalent metals. In these embodiments the stoichiometric equation is

M₂(CO₃)₃+n SiO₂→M₂O₃.n SiO₂+3 CO₂⬆. [1c]

The flame-retardant substance according to the present invention may be a mixture of the products formed in [1a], [1b] and/or [1c].

The flame-retardant substance may be formed under pressure and/or heat, preferably in an aqueous solution. The flame-retardant substance may form a sol or a gel. Upon contact with fire or heat the flame-retardant substance may lose water and may harden to a fire resistant solid.

The consistency of the flame-retardant substance according to the above chemical composition is preferably liquid or jelly-like. Accordingly, the flame-retardant liquid is also referred to as “Watergel” or water glass.

The flame-retardant substance according to the invention can be used straight/undiluted or diluted/thinned. The thinning ratio of the flame-retardant substance is preferably up to 1 to 10, so that one liter of water contains at least 100 milliliters of the flame-retardant substance. The flame-retardant substance may be sold in a can of e.g. five liter volume as a diluted ready-made mixture. Alternatively, flame-retardant substance may be sold in a can of e.g. two liters volume in an undiluted state as a base for subsequent dilution. Naturally, the flame-retardant substance can also be applied in an undiluted state to any objects to be protected against fire. Preferably, the flame-retardant substance is used in a mixture together with a clay. This mixture is also referred to herein as flame-retardant composition. More preferably, the mixture or flame-retardant composition contains the flame-retardant substance of the first or second embodiment and clay in a ratio (w/w) of between 100:1 and 5:1, preferably between 50:1 and 10:1, more preferably 20:1 and 12:1. Preferably, the ratio is the ratio of the dry components flame-retardant substance to clay. In one embodiment, water glass is admixed with kaolin (preferably Kaolinum ponderosum or Bolus alba) in a ratio (w/w) of between 50:1 and 10:1, more preferably 20:1 and 12:1. In another embodiment, sodium silicate is admixed with kaolin (preferably Kaolinum ponderosum or Bolus alba) in a ratio of between 50:1 and 10:1, more preferably 20:1 and 12:1. Water or an aqueous solution may be added to the compositions of the third embodiment of the invention.

### Flame-Retardant Fabric

The flame-retardant fabric 3, also called fire-proof fabric, according to the invention is composed of pure silica glass in compound with aramide and/or aluminum silicate. It is preferably woven from fibers made from at least one of these materials. For the most efficient protection against fire according to a high-risk standard, about 100 milliliters of the flame-retardant substance are required per square meter of the flame-retardant fabric 3. The flame-retardant substance can be applied to the flame-retardant fabric 3 in any possible way, preferably by dotting and/or immersing the fabric, and/or filling cavities contained in the fabric and/or an underlay to the fabric 3.

To obtain the highest possible protective effect, the flame-retardant fabric 3 is used in three layers. Commercially available plastic foils of any strength can be used for filling an underlay, i.e. a layer underneath the fabric 3, with the flame-retardant substance.

### FIELD OF USE OF THE INVENTION

For covering objects to be protected against fire, in particular forest fire, e.g. in case of flying sparks and a moderate thermal load, the flame-retardant fabric 3 without the flame-retardant substance is fully sufficient.

Hence, flame-retardant fabric 3 without the flame-retardant substance is useful for protecting garden sheds, vehicles and smaller annexes or extensions to existing buildings.

Sprinkling of the diluted or undiluted flame-retardant substance yet provides simple protection of tree population, lawn, meadow, and the like in case of danger to the own property e.g. by flying sparks.

As a preventive measure for protecting any objects against fire, in particular wooden objects and constructions, such as cabins or wooden sheds, a simple surface treatment, e.g. by glazing or pressure impregnation, with the undiluted or diluted flame-retardant substance is sufficient and sustainable. The preferred thinning ratio of the flame-retardant substance for surface treatment of objects to be protected against fire is not more than 1 to 5 by volume or weight (i.e. not more than five parts of water to one part of the flame-retardant substance). The advantage of the flame-retardant substance according to the invention is that no (visible) residues remain on the treated object.

A simple protection of objects can also be obtained with a flame-retardant fabric 3 according to the invention having at least three layers.

In case of flying sparks in combination with high thermal loads due to radiation, a more advanced protection of objects against fire may prove useful. In this case, the three layer flame-retardant fabric 3 containing the flame-retardant substance provides the highest possible protection and isolation against long-term thermal impact with temperatures of 800 to 1,000° C. It is noted that the flame-retardant substance according to the invention must not necessarily be contained in the flame-retardant fabric 3. For example, the flame-retardant substance according to the invention may be contained in an underlay or bedding layer to be arranged on the inside of the flame-retardant fabric 3, opposite to the fire front.

The flame-retardant fabric according to the invention may be embodied as a shutter, jalousie, curtain, sheet, mat, tissue and the like, and may have a soft or rigid structure.

The flame-retardant substance according to the invention may be applied to the flame-retardant fabric according to the invention or to any object to be protected against fire by spraying, sprinkling, glazing, dotting, immersing, filling and the like in an undiluted or diluted state. If diluted, a thinning ratio of the flame-retardant substance according to the invention is preferably not more than 1 to 10 (i.e. not more than ten parts of water to one part of the flame-retardant substance, preferably measured by volume or weight), 1 to 9, 1 to 8, 1 to 7, 1 to 6, 1 to 5, 1 to 4, 1 to 3 or 1 to 2.

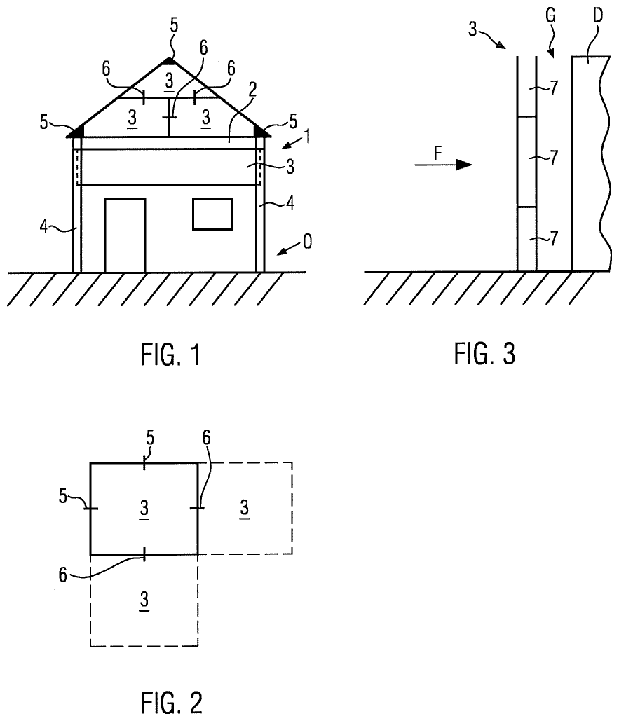

As shown in FIG. 1, which is a schematic front view of object O in the form of a house furnished with a fire protection device 1 according to the present invention, a case 2 containing the flame-retardant fabric 3 is installed under the roofline. In this embodiment, the flame-retardant fabric 3 is embodied as a jalousie, which is regularly stored in the case 2 in a retracted configuration. As shown in FIG. 1, the flame-retardant fabric 3 is partially deployed to extend outside the case 2 and to cover the upper part of the front side of the object O. Both side edges of the flame-retardant fabric 3 along the deployment direction are guided in guides 4 installed at both edges of the front side of the house. The guides 4 are heat-resistant and fire-proof and preferably from metal. In a cross-section perpendicular to the deployment direction, the guides 4 have an L-shaped or a U-shaped profile so as to extend on the outer side (L-shaped profile) or on the outer side and the inner side (U-shaped profile) of the deployed flame-retardant fabric 3. Preferably, the guides 4 engage with the edges of the flame-retardant fabric 3 in a form-fit fashion, so that the flame-retardant fabric 3 cannot escape from the guides 4, even when pressure is applied to the outside of the flame-retardant fabric 3, which is exposed to the flame front. As shown in FIG. 1, as set of coupleable flame-retardant fabrics 3 of another type may be used to cover the roof of the housing, wherein the shape of the set of coupled flame-retardant fabrics 3 is configured to correspond to the shape of the roof. The set of coupled flame-retardant fabrics 3 is fixed to the object O by means of latching devices 5 and the flame-retardant fabrics 3 are coupled with each other by means of coupling devices 6.

FIG. 2 is a schematic top view of a set of coupleable rectangular flame-retardant fabrics 3 coupled with each other by coupling devices 6 in an abutting configuration, wherein the set can be fixed to the object to be protected though latching devices 5.

FIG. 3 is a schematic view of a flame-retardant fabric 3 containing cavities 7 filled with the flame-retardant substance, wherein the flame-retardant fabric 3 is provided with a gap G in front of the object O and exposed to the flame front F.

### Preferred Uses

The flame retardant composition of the invention (preferably a mixture of waterglass and kaolin) is suitable to protect many flammable materials against fire and to prevent many flammable materials from catching fire, respectively.

Such a material comprises an insulating material, a wooden material (living or not-living), a paint, a finish, or a fabric.

The insulating material may be made from or may contain foam glass, glass wool, mineral wool, styrofoam/EPS, Expanded clay, calcium silicate, perlite; PUR/PIR, XPS, flax, hemp, seagrass, wood wool, coconut fiber, felt, cork, sheep wool, cellulose, planer spun, cotton, glimerschief, a textiles, an expansion joint, a silicone, a silicate, or mixtures of any of these.

Another insulating material may be a cellulosic foam board, a cellulose flake, a blow-in, a hemp barrier board, a Cotton flake, a natural fiber, a wood fiber insulation board, a pressboard board, a reed pipe or a light construction board.

Another material is an additive used in the production of insulating materials, e.g. an additive made from a regenerative product, a leave (foliage) or the like.

The wooden material may comprise a plants or a tree or parts or elements thereof. Trees or plants may soak the flame retardant composition of the invention. In such an embodiment the plant or tree may be but into a vessel or container including the flame retardant composition of the invention together (e.g. in an aqueous solution or suspension). Plants and trees are thereby impregnated from the inside an will not catch fire.

The flame retardant composition of the invention may be used as an admixture or additive to a high press fire extinguishes, or a charge-extinguisher, preferably the flame retardant composition are used in an injector mode.

The flame retardant composition of the invention may be used in forest or field fires as medium spreaded in aisles.

The flame retardant composition of the invention may be dropping with outer load containers from helicopters or other flying vehicles.

The flame retardant composition of the invention may be used applied to a hydroshield as a fire protection surface.

### LIST OF REFERENCE SIGNS

1 Fire protection device
2 Case
3 Sheet
4 Guide
5 Latching device
6 Coupling device
7 Cavity
F Flame Front
O Object
G Gap

1. A flame-retardant substance for application to objects to be protected against fire including forest fire, wherein the flame-retardant substance is obtained by a chemical reaction according to the formula:
M₂(CO₃)ₓ+n Si0₂→M₂Oₓ.n SiO₂+x CO₂⬆,
wherein x may be 1, 2 and/or 3 and n is an integer between 1 and 10.

2. The flame-retardant substance according to claim 1, wherein the flame-retardant substance is liquid and/or thinned with a thinning agent up to a thinning ratio of not more than 1 to 10 by volume or weight.

3. A flame-retardant composition comprising the flame-retardant substance of claim 1 mixed with a clay mineral.

4. The flame-retardant composition of claim 3, wherein the clay mineral is porcelain clay or kaolin.

5. The flame-retardant composition of claim 4, wherein the kaolin is Kaolinum ponderosum or Bolus alba.

6. The flame-retardant composition of claim 3, wherein the ratio (w/w) of flame-retardant substance to clay mineral is between 50:1 and 10:1.

7. Flame-retardant fabric for covering objects to be protected against fire including forest fire, comprising: at least one woven layer containing one or more of silica glass, aramide, or aluminum silicate.

8. Object treated with the flame-retardant substance according to claim 1, wherein the flame-retardant substance or composition is applied to the object in a liquid state by spraying, sprinkling, glazing, dotting, immersing and/or filling.

9. A method of using the flame-retardant substance according to claim 1, for protecting a flammable object against fire, the method comprising:
applying the flame-retardant substance in a liquid state to the flammable object by spraying, sprinkling, glazing, dotting, immersing and/or filling; or
covering the flammable object to be protected from fire with the flame-retardant substance.

10. The method of claim 9, wherein the flammable object is an insulting material, a paint, a finish, or a fabric or a wooden material.

11. The flame-retardant composition of claim 3, wherein the flame-retardant substance or composition is applied to the object in a liquid state by spraying, sprinkling, glazing, dotting, immersing and/or filling.

12. A method using the flame-retardant composition according to claim 3 for protecting a flammable object against fire, the method comprising:
applying the flame-retardant substance mixed with a clay mineral to the flammable object to be protected by spraying, sprinkling, glazing, dotting, immersing and/or filling; or
covering the flammable object with the flame-retardant substance mixed with a clay mineral.

13. The flame-retardant fabric of claim 7, comprising: fibers of pure silica glass in compound with aramide and/or aluminum silicate.

14. The flame-retardant fabric of claim 13, comprising: two, three or more identical or different layers.

15. The method of claim 9, wherein objects are covered with at least one woven layer containing one or more of silica glass, aramide, or aluminum silicate.
